(19) United States
(12) Patent Application Publication
(10) Pub. No.: US 2012/0027582 A1
(43) Pub. Date: Feb. 2, 2012

(54) FLOATING PACKING RING ASSEMBLY

(75) Inventors: Rajasekar Natarajan, Bangalore (IN); Rakesh Vamsi Alamsetty, Bangalore (IN); Mahendra Singh Mehra, Bangalore (IN); Nestor Hernandez Sanchez, Schenectady, NY (US); Manikandan Srinivasan, Bangalore (IN)

(73) Assignee: GENERAL ELECTRIC COMPANY, Schenectady, NY (US)

(21) Appl. No.: 12/848,333

(22) Filed: Aug. 2, 2010

(51) Int. Cl. F04D 29/04; F01D 11/08; F04D 29/08; F16J 15/44; F16J 15/46; F16J 15/447; F16J 15/16; F01D 11/02; F01D 11/00

(52) U.S. Cl. 415/229; 277/579; 277/355; 277/412; 277/583

(57) ABSTRACT

A packing ring assembly for use between a rotating and a stationary component in a turbomachine is disclosed, the assembly including an arcuate packing ring casing, an arcuate packing ring segment positioned at least partially within the packing ring casing, and a resistance component configured to allow movement of the packing ring segment in an axial direction, relative to the rotating component, between a first and second position in response to a pressure condition. In one embodiment, the resistance component allows movement when the pressure condition comprises approximately 30% of the turbomachine load. Also disclosed is an altered surface topography of the rotating component to accommodate variable length teeth extending from the packing ring segment, such that when the packing ring segment is in the first position, a clearance between the packing ring segment and the rotating component is larger than when the packing ring segment is in the second position.

### BACKGROUND OF THE INVENTION

The disclosure relates generally to rotary turbomachines, and more particularly, to a floating packing ring assembly for use in a turbomachine to avoid transient rubs.

In rotary machines such as turbines, seals are provided between rotating and stationary components. For example, in steam turbines, it is customary to provide a plurality of arcuate packing ring segments to form an annular labyrinth seal between the stationary and rotating components. Typically, the arcuate packing ring segments (typically, four to six per annular seal) are disposed in an annular groove in the stationary component concentric to the axis of rotation of the machine and hence concentric to the sealing surface of the rotating component. Each arcuate seal segment carries an arcuate seal face in opposition to the sealing surface of the rotating component. In labyrinth type seals, the seal faces carry a radially directed array of axially spaced teeth, which teeth are radially spaced from an array of axially spaced annular teeth forming the sealing surface of the rotating component. The sealing function is achieved by creating turbulent or flow restriction of an operative fluid, for example, steam, as it passes through the relatively tight clearances within the labyrinth defined by the seal face teeth and the opposing surface of the rotating component.

The ability to maintain proper clearances without physical contact between the rotating equipment and stationary components allows for the formation of an effective seal. If this radial clearance between the seal faces of the segments and the opposing seal surfaces of the rotating component becomes too large, less restriction is produced and the sealing action is compromised. Conversely, if the clearance is too tight, the sealing teeth may contact the rotating element, with the result that the teeth lose their sharp profile and tight clearance and thereafter create less restriction, likewise compromising the sealing action.

In order to create and maintain a desired seal and to avoid damage to the rotor and packing ring during transient conditions, positive pressure, variable clearance packing rings may be used, for example, a packing ring as disclosed in U.S. Pat. No. 7,384,235 in which a spring assembly is provided which retracts the packing rings radially in and out of the rotor to maintain clearances.

### BRIEF DESCRIPTION OF THE INVENTION

A packing ring assembly for use between a rotating and a stationary component in a turbomachine is disclosed, the assembly including an arcuate packing ring casing, an arcuate packing ring segment positioned at least partially within the packing ring casing, and a resistance component configured to allow movement of the packing ring segment in an axial direction, relative to the rotating component, between a first and second position in response to a pressure condition. In one embodiment, the resistance component allows movement when the pressure condition comprises approximately 30% of the turbomachine load. Also disclosed is an altered surface topography of the rotating component to accommodate variable length teeth extending from the packing ring segment, such that when the packing ring segment is in the first position, a clearance between the packing ring segment and the rotating component is larger than when the packing ring segment is in the second position.

A first aspect of the disclosure provides a packing ring assembly for use between a rotating and a stationary component in a turbomachine, the assembly comprising: an arcuate packing ring casing having an annular groove; an arcuate packing ring segment having a mounting portion and a sealing portion, wherein the mounting portion is positioned at least partially within the annular groove and the sealing portion is proximate to the rotating component; and a resistance component configured to allow movement of the packing ring segment in an axial direction, relative to the rotating component, between a first and second position in response to a pressure condition.

A second aspect of the disclosure provides a turbomachine comprising: a substantially cylindrical rotating component; and a stationary component including a packing ring assembly, the packing ring assembly comprising: an arcuate packing ring casing having an annular groove; an arcuate packing ring segment having a mounting portion and a sealing portion, wherein the mounting portion is positioned at least partially within the annular groove and the sealing portion is proximate to the rotating component; and a resistance component configured to allow movement of the packing ring segment in an axial direction, relative to the rotating component, between a first and second position in response to a pressure condition.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a partial cross-sectional view of an illustrative turbomachine as known in the art.

FIG. 2 is a cross-sectional view of a packing ring assembly for use between rotating and stationary components of a turbomachine as known in the art.

FIGS. 3-5 show cross-sectional views of a packing ring assembly for use between a rotating and stationary component of a turbomachine according to embodiments of this invention.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

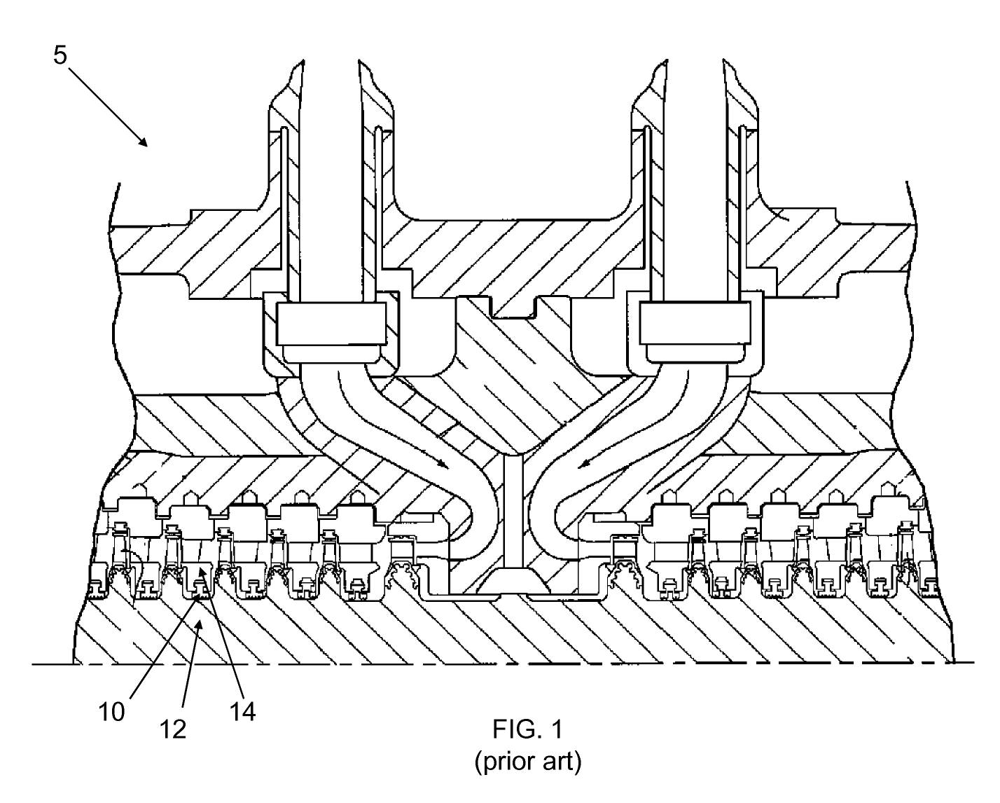

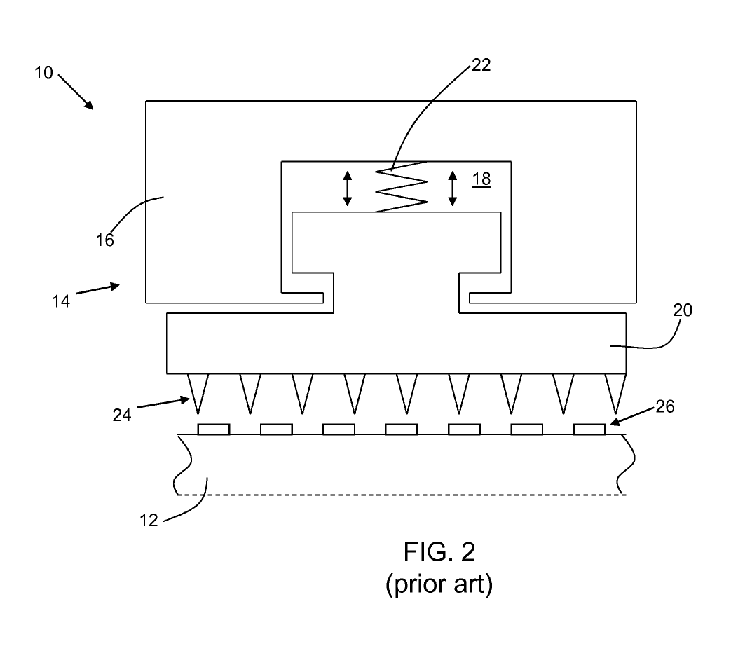

Turning to FIG. 1, a portion of a turbomachine 5, as known in the art, is shown. Turbomachine 5 includes a plurality of arcuate packing ring assemblies 10 to provide a seal between a rotating component 12 and a stationary component 14. One such packing ring assembly 10, as known in the art, is shown in FIG. 2. Assembly 10, as shown in FIG. 2, includes at least one arcuate packing ring casing 16, at least partially positioned within stationary component 14. Packing ring casing 16 has an annular groove 18. At least one arcuate packing ring segment 20 is also provided, positioned at least partially within annular groove 18. Assembly 10 further includes a spring 22 for moving packing ring segment 20. Spring 22 is positioned within annular groove 18, between packing ring casing 16 and packing ring segment 20, on a side of packing ring segment 20 that is radially opposite rotating component 12. Spring 22 is configured such that it allows packing ring segment 20 to move in a radial direction, i.e., to and from rotating component 12, as indicated by the arrows in FIG. 2.

Packing ring segment 20, shown in FIG. 2, further includes a plurality of teeth 24 that extend radially from packing ring segment 20 towards rotating component 12. As spring 22 moves ring segment 20 to and from rotating component 12, teeth 24 move to and from rotating component 12. Rotating component 12 can also include a plurality of protrusions 26 extending from the surface of rotating component 12. This arrangement is generally referred to as a labyrinth seal, because when packing ring segment 20 is moved closer to rotating component 12, teeth 24 move closer to protrusions 26, thereby providing non-contact sealing action between rotating component 12 and packing ring segment 20, by effectively forcing operative fluid of the turbomachine to travel a tortuous path between teeth 24 and protrusions 26.

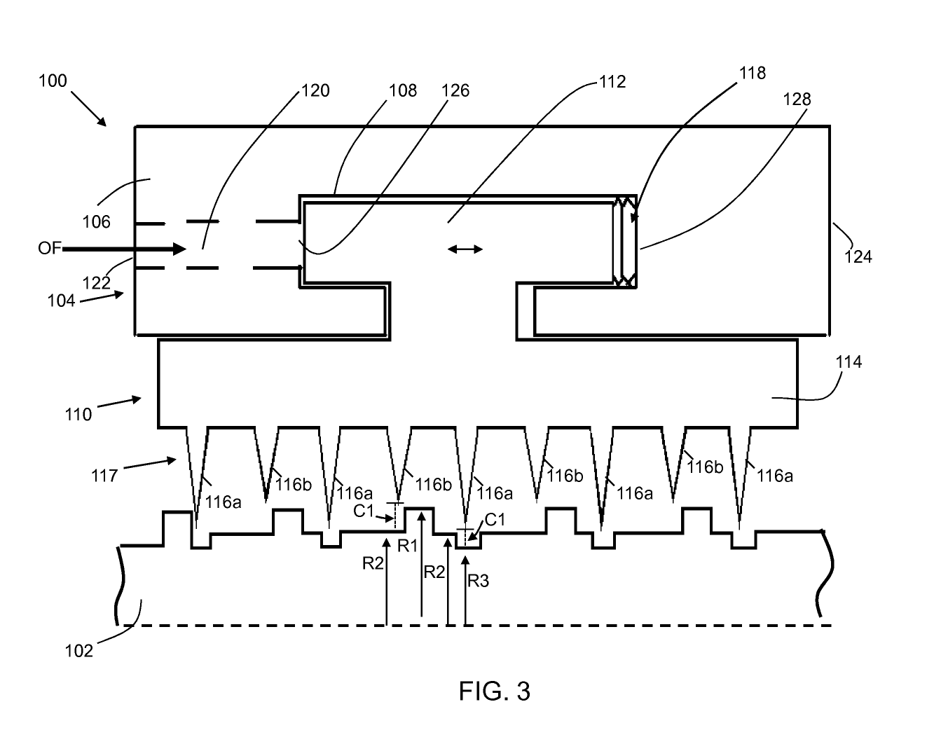

Turning to FIG. 3, a packing ring assembly 100 according to an embodiment of this invention is disclosed. Packing ring assembly 100 is used between a substantially cylindrical rotating component 102 (partially shown) and a stationary component 104 in a turbomachine (such as turbomachine 5 partially shown in FIG. 1). Stationary component 104 includes at least one arcuate packing ring casing 106 having an annular groove 108. As shown in FIG. 3, packing ring casing 106 has an upstream axial face 122 and a downstream axial face 124. Annular groove 108 also has an upstream inside axial face 126 (axially opposite upstream axial face 122) and a downstream inside axial face 128 (axially opposite downstream axial face 124). Packing ring assembly 100 further includes at least one arcuate packing ring segment 110 having a mounting portion 112 and a sealing portion 114, wherein mounting portion 112 is positioned at least partially within annular groove 108 and sealing portion 114 is proximate to rotating component 102.

Sealing portion 114 can further include at least one sealing member 117 that extends in a radial direction from packing ring segment 110 towards rotating component 102. FIG. 3 shows the at least one sealing member 117 as a plurality of teeth 116a, 116b that extend in a radial direction towards rotating component 102, but any known sealing means can also be utilized with embodiments of this invention. For example, sealing member 117 can be a leaf seal, a brush seal, a labyrinth seal (including Hi-Lo, straight/smooth, slant/smooth, Hi-Lo/smooth types of labyrinth seals), a finger seal, a compliant plate seal, a shingle seal, a honeycomb seal, an abradable seal, or any other now known or later discovered sealing means between rotating and stationary components. It is also understood that the embodiments of this invention can be applied to various regions of a turbomachine that require sealing, such as root sealing, tip sealing, end packing and mid packing regions of turbomachines.

Packing ring assembly 100 further includes a resistance component 118 for allowing movement of packing ring segment 110 in an axial direction, relative to rotating component 102. In one embodiment, resistance component 118 is positioned in annular groove 108, between mounting portion 112 of packing ring segment 110 and downstream inside axial face 128 of annular groove 108. Resistance component 118 may be positioned within annular groove 108 by coupling it to either mounting portion 112 or packing ring casing 106, or both. As such, resistance component 118 can at least partially support packing ring segment 110 because as a portion of resistance component 118 is attached to packing ring casing 106, and a portion of resistance component 118 is attached to mounting portion 112, mounting portion 112 will be suspended, i.e., floated, within annular groove 108. Packing ring assembly 100 is referred to as a “floating” seal arrangement because packing ring 110 can be positioned, i.e., ‘floated’, in an axial direction in packing ring casing 106 due to a pressure of the operating fluid flowing through the turbomachine and a stiffness of resistance component 118. Any known means of attaching resistance component 118 can be used, including welding, brazing, adhesive bonding, diffusion bonding, mechanical joining including but not limited to dovetail joints, mortise and tendon joints, flexible and sliding joints, threaded holes, screws or nuts or bolts.

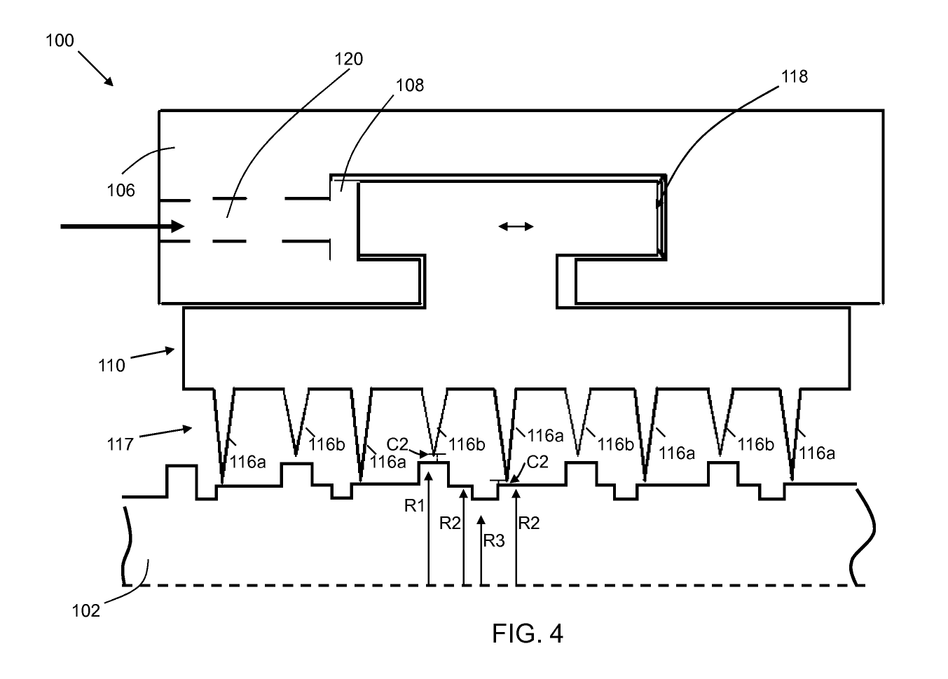

Resistance component 118 can comprise any known means that can be configured to allow packing ring segment 110 to move axially between a first and second position, relative to rotating component 112. Suitable means can include a hydraulic, pneumatic or electromagnetic resistance component that is configured to compress, or move, in response to a pressure condition, to allow packing ring segment 110 to move in an axial direction. For example, as discussed in more detail herein, FIG. 3 shows a spring 118, positioned in annular groove 108, configured such that spring 118 maintains packing ring segment 110 in its first position (FIG. 3) and then, in response to a pressure condition in annular groove 108, spring 118 allows packing ring segment 110 to move in an axial direction into its second position (FIG. 4). In one example, spring 118 may have a stiffness such that it requires an operative force of approximately 30% of the turbomachine load to compress and allow movement, therefore, the pressure condition could comprise a pressure in annular groove 108 of approximately 30% of the turbomachine load. Another example of a resistance component 118 that could be used is a configuration similar to this embodiment is a bellows, which would compress and decompress similar to a spring. While the use of one resistance component 118 is discussed herein and shown in FIGS. 3-5, it is understood that one or more suitable means could be used. Resistance component 118 can be compressive or tensile as mounted.

As discussed herein, resistance component 118 can be configured such that, in response to a pressure condition in annular groove 108, resistance component 118 allows packing ring segment 110 to move in an axial direction. In one embodiment, this pressure condition can be passively controlled. For example, packing ring casing 106 can further include at least one opening 120 extending from upstream axial face 122 of packing ring casing 106 to upstream inside axial face 126 of annular groove 108, wherein opening 120 is configured to allow operating fluid, OF, of the turbomachine to travel through opening 120 into annular groove 108 to contact mounting portion 112 of packing ring segment 110. Opening 120 can comprise an opening or hole of any desired shape or configuration and can be positioned in packing ring casing 106 as desired. FIG. 3 shows one configuration where opening 120 extends substantially axially from upstream face 122 of packing ring casing 106 to upstream inside axial face 126 of annular groove 108, and resistance component 118 is positioned between mounting portion 112 and downstream inside axial face 128 of packing ring casing 106, axially opposite opening 120. While one opening 120 is shown in FIG. 3, it is understood that multiple openings 120 can be included in packing ring casing 106 in keeping with this embodiment of the invention. In addition, it is understood that openings 120 can be oriented at different angles than substantially axially (as shown in FIG. 3) through packing ring casing 106. Also, the location of openings 120 and resistance component 118 can be interchanged based on design needs.

As operative fluid (OF) of the turbomachine travels through opening 120 (illustrated by arrow “OF” in FIG. 3) and enters annular groove 108, a pressure condition within annular groove 108 may change. In response to this pressure condition, resistance component 118 allows packing ring segment 110 to move in an axial direction. For example, resistance component 118 may require a force of approximately 30% of the turbomachine load to allow movement, that is, when the pressure condition comprises a force of the operating fluid of approximately 30% of a load of the turbomachine, resistance component 118 allows movement (for example, by being compressed or decompressed when in the form of a spring or bellows), and packing ring segment 110 can move axially from a first position to a second position (FIG. 3 to FIG. 4). In other words, when the pressure within annular groove 108 is below approximately 30% of the turbomachine load, resistance component 118 does not allow movement and packing ring segment 110 remains in its first position (FIG. 3). Once the pressure within annular groove 108 reaches approximately 30% of the turbomachine load, resistance component 118 allows movement and packing ring segment 110 moves to its second position (FIG. 4).

Turning to FIG. 4, packing ring assembly 100 is shown when resistance component 118 has allowed movement and packing ring segment 110 is in its second position. In other words, packing ring segment 110 has moved in an axial direction relative to rotating component 102. This axial movement of packing ring segment 110 is illustrated in FIGS. 3 and 4 by the double arrows. When packing ring segment 110 is in the first position (FIG. 3) a clearance, C1, between sealing member 117 of packing ring segment 110 and rotating component 102 is larger than the clearance, C2, between sealing member 117 of packing ring segment 110 and rotating component 102 when packing ring segment 110 is in the second position (FIG. 4). Therefore, sealing member 117 is closer to rotating component 102 when packing ring segment 110 is in the second position.

Turning back to FIG. 3, the configuration of sealing member 117 and rotating component 102 can also be modified from existing labyrinth seal configurations according to embodiments of this invention. For example, sealing member 117 can comprise a plurality of teeth 116a, 116b of variable lengths, and a surface of rotating component 102 can be modified to include a plurality of valleys and peaks to accommodate the varying lengths of teeth 116a, 116b. In other words, as shown in FIG. 3, teeth 116 can include a first set of teeth 116a having a first length and a second set of teeth 116b having a second length, wherein the first length is longer than the second length. The first set of teeth 116a (the longer teeth) can alternate with the second set of teeth 116b (the shorter teeth) as shown in FIG. 3, or can be arranged in any desired pattern. In addition, a surface topography of rotating component 102 can be altered to include at least three different radii, R1, R2 and R3, wherein radius R1 is larger than radius R2 and radius R2 is larger than radius R3, as illustrated in FIGS. 3 and 4.

The movement of packing ring segment 110 in an axial direction as discussed herein allows variable length teeth 116a, 116b and rotating component 102 with a variable surface topography to interact in a way that provides a sealing arrangement between packing ring segment 110 and rotating component 102. As shown in FIG. 3, when packing ring segment 110 is in the first position, first set of teeth 116a are proximate to a surface of rotating component 102 having the R3 radius and second set of teeth 116b are proximate to a surface of rotating component 102 having the R2 radius. As shown in FIG. 4, when packing ring segment 110 is moved axially into the second position, first set of teeth 116a are proximate to a surface of rotating component 102 having the R2 radius and second set of teeth 116b are proximate to a surface of rotating component 102 having the R1 radius. Therefore, and as shown in FIGS. 3 and 4, when packing ring segment 110 is in the second position (FIG. 4), clearance C2 between teeth 116a, 116b is smaller than clearance C1 between teeth 116a, 116b when packing ring segment 110 is in the first position (FIG. 3). When describing teeth 116a, 116b as being “proximate” to a particular surface of rotating component 102, it is understood that “proximate” in this context means that teeth 116a, 116b are near, or close to, that particular surface of rotating component 102, or are substantially radially aligned with that particular surface of rotating component 102.

This movement of the packing ring segment 110 axially between a first position as shown in FIG. 3 and second position as shown in FIG. 4 helps in avoiding rubs and severe damage to packing ring segment 110. This, in turn, helps in reducing the degradation of the turbomachinery section efficiencies under steady state operations. In particular, during turbomachine transient conditions such as start-up, shut-down, speed ramp-up, load ramp-up, forward-flow/reverse flow, trip, turning gear operation and at low loads when the vibration levels are higher, resistance component 118 will maintain packing seal segment 110 in the first position (FIG. 3) to maintain a larger clearance C1 between packing seal segment 110 and rotating component 102. Once the turbomachine is in normal operational mode, for example, when the operative fluid moving through the turbomachine reaches a certain pressure, resistance component 118 will allow movement of packing seal segment 110 into the second position (FIG. 4) to create smaller clearance C2 between packing seal segment 110 and rotating component 102.

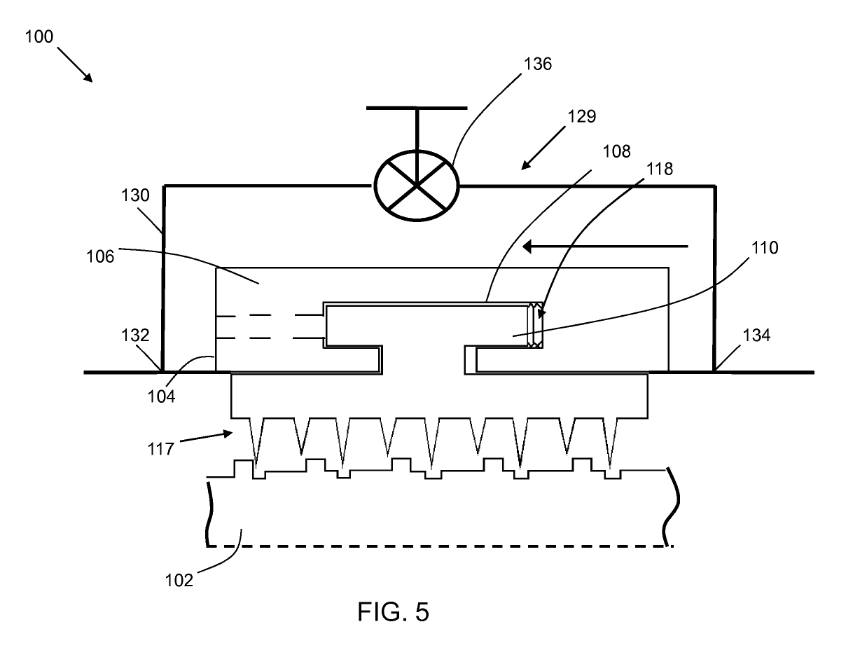

In another embodiment, the pressure condition within annular groove 108 can be actively controlled to move packing ring segment 110. In other words, the pressure condition can be manipulated to be a certain pressure, rather than relying on the natural flow of the operating fluid through opening(s) 120 to create the pressure condition. For example, as shown in FIG. 5, a fluid bypass system 129 can be used to direct operating fluid of the turbomachine around packing ring segment 110 in order to control the pressure condition within annular groove 108. Again, as with the passively controlled system disclosed herein, fluid bypass system 129 can be used to control the pressure condition within annular groove 108 such that once the pressure within annular groove 108 reaches a certain pressure, e.g., approximately 30% of the turbomachine load, resistance component 118 is compressed and allows packing ring segment 110 to move to its second position.

Fluid bypass system 129 can comprise a series of pipes or conduits configured to direct the operating fluid of the turbomachine around packing ring segment 110. For example, as shown in FIG. 5, fluid bypass system 129 can include at least one conduit or pipe 130 extending from an inlet 132 at a location in stationary component 104 upstream of packing ring segment 110 to an outlet 134 at a location in stationary component 104 downstream of packing ring segment 110. Inlet 132 is configured to redirect operating fluid that normally travels through the turbomachine between packing ring segment 110 and rotating component 102, through fluid bypass system 129, and around packing ring segment 110.

At least one bypass control valve 136 is located between inlet 132 and outlet 134 for controlling flow through fluid bypass system 129. Valve 136 may be operated manually or automatically. Automatic operation can be either direct or in conjunction with a machine controller. When valve 136 is open, fluid bypass system 129 offers significantly less resistance to flow as compared to the leakage between sealing members 117 and rotating component 102. This results in a significant reduction in pressure drop across packing ring segment 110. An example of an actively activated fluid bypass system is disclosed in U.S. Pat. Pub. No. 2008/0169616.

A labyrinth seal is shown in the figures herein to illustrate embodiments of this invention, but as one of skill in the art would understand, packing ring assembly 100 disclosed herein can be used on any type of seal used between rotating and stationary components in a turbomachine, including but not limited to brush seals, leaf seals, finger seals, compliant plate seals, shingle seals, honeycomb seals and abradable seals.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A packing ring assembly for use between a rotating and a stationary component in a turbomachine, the assembly comprising:
an arcuate packing ring casing having an annular groove;
an arcuate packing ring segment having a mounting portion and a sealing portion, wherein the mounting portion is positioned at least partially within the annular groove and the sealing portion is proximate to the rotating component; and
a resistance component configured to allow movement of the packing ring segment in an axial direction, relative to the rotating component, between a first and second position in response to a pressure condition.

2. The packing ring assembly of claim 1, wherein the resistance component is selected from the group consisting of: a spring and a bellows.

3. The packing ring assembly of claim 1, wherein the sealing portion of the arcuate packing ring segment includes a sealing member that extends in a radial direction from the arcuate packing ring segment towards the rotating component, and wherein the sealing member is selected from the group consisting of a leaf seal, a brush seal, a labyrinth seal, a finger seal, and a compliant seal.

4. The packing ring assembly of claim 1, wherein the sealing portion includes a plurality of teeth that extend in a radial direction from the arcuate packing ring segment towards the rotating component, wherein the plurality of teeth include a first set of teeth having a first length and a second set of teeth having a second length, wherein the first length is longer than the second length.

5. The packing ring assembly of claim 4, wherein a surface of the rotating component includes surfaces having at least three different radii, R1, R2 and R3, wherein radius R1 is larger than radius R2 and radius R2 is larger than radius R3, and wherein in the first position, the first set of teeth are proximate to a surface of the rotating component having the R3 radius and the second set of teeth are proximate to a surface of the rotating component having the R2 radius, and in the second position, the first set of teeth are proximate to a surface of the rotating component having the R2 radius and the second set of teeth are proximate to a surface of the rotating component having the R1 radius.

6. The packing ring assembly of claim 5, wherein in response to the arcuate packing ring segment being in the first position, a clearance between the arcuate packing ring segment and a rotating component is larger than the clearance between the arcuate packing ring segment and the rotating component in the second position.

7. The packing ring assembly of claim 1, wherein the arcuate packing ring casing further includes an opening extending from a first side of the arcuate packing ring casing to a first axial face of the annular groove, wherein the opening is configured to allow operating fluid of the turbomachine to travel through the opening into the annular groove to contact the arcuate packing ring segment.

8. The packing ring assembly of claim 7, wherein the resistance component is positioned between the mounting portion of the arcuate packing ring segment and a second axial inside face of the annular groove, axially opposite the at least one opening.

9. The packing ring assembly of claim 1, wherein the pressure condition comprises a pressure in the annular groove of approximately 30% of a load of the turbomachine.

10. The packing ring assembly of claim 1, further comprising a fluid bypass system for directing operating fluid of the turbomachine around the arcuate packing ring segment in order to control the pressure condition within the annular groove.

11. The packing ring assembly of claim 10, wherein the fluid bypass system further includes a valve to control fluid flow through the fluid bypass system.

12. A turbomachine comprising:
a substantially cylindrical rotating component; and
a stationary component including a packing ring assembly, the packing ring assembly comprising:
an arcuate packing ring casing having an annular groove;
an arcuate packing ring segment having a mounting portion and a sealing portion, wherein the mounting portion is positioned at least partially within the annular groove and the sealing portion is proximate to the rotating component; and
a resistance component configured to allow movement of the packing ring segment in an axial direction, relative to the rotating component, between a first and second position in response to a pressure condition.

13. The turbomachine of claim 12, wherein the resistance component is selected from the group consisting of: a spring and a bellows.

14. The turbomachine of claim 12, wherein the pressure condition comprises a pressure in the annular groove of approximately 30% of a load of the turbomachine.

15. The turbomachine of claim 12, wherein the sealing portion of the arcuate packing ring segment includes a sealing member that extends in a radial direction from the arcuate packing ring segment towards the rotating component, and wherein the sealing member is selected from the group consisting of a leaf seal, a brush seal, a labyrinth seal, a finger seal, and a compliant seal.

16. The turbomachine of claim 12, wherein the sealing portion includes a plurality of teeth that extend in a radial direction from the arcuate packing ring segment towards the rotating component, wherein the plurality of teeth include a first set of teeth having a first length and a second set of teeth having a second length, wherein the first length is longer than the second length.

17. The turbomachine of claim 16, wherein a surface of the rotating component includes surfaces having at least three different radii, R1, R2 and R3, wherein radius R1 is larger than radius R2 and radius R2 is larger than radius R3, and wherein in the first position, the first set of teeth are proximate to a surface of the rotating component having the R3 radius and the second set of teeth are proximate to a surface of the rotating component having the R2 radius, and in the second position, the first set of teeth are proximate to a surface of the rotating component having the R2 radius and the second set of teeth are proximate to a surface of the rotating component having the R1 radius.

18. The turbomachine of claim 17, wherein in response to the arcuate packing ring segment being in the first position, a clearance between the arcuate packing ring segment and a rotating component is larger than the clearance between the arcuate packing ring segment and the rotating component in the second position.

19. The turbomachine of claim 12, wherein the arcuate packing ring casing further includes an opening extending from a first side of the arcuate packing ring casing to a first axial face of the annular groove, wherein the opening is configured to allow operating fluid of the turbomachine to travel through the opening into the annular groove to contact the arcuate packing ring segment, and wherein the resistance component is positioned between the mounting portion of the arcuate packing ring segment and a second axial face of the annular groove, axially opposite the at least one opening.

20. The turbomachine of claim 12, further comprising a fluid bypass system for directing operating fluid of the turbomachine around the arcuate packing ring segment in order to control the pressure condition within the annular groove, wherein the fluid bypass system further includes a valve to control fluid flow through the fluid bypass system.
